(19) United States
(12) Patent Application Publication
(10) Pub. No.: US 2026/0300191 A1
(43) Pub. Date: Oct. 1, 2026

(54) INFORMATION PROCESSING DEVICE, INFORMATION PROCESSING SYSTEM, AND INFORMATION PROCESSING METHOD

(71) Applicant: Hitachi, Ltd., Tokyo (JP)

(72) Inventors: Yuki TANAKA, Tokyo (JP); Kotaro SHIMAMURA, Tokyo (JP); Kosuke TODA, Tokyo (JP)

(21) Appl. No.: 19/543,210

(22) Filed: Feb. 18, 2026

(30) Foreign Application Priority Data
Mar. 31, 2025 (JP) 2025-058905

(51) Int. Cl. G06F 13/16; G06F 9/38

(52) U.S. Cl. CPC G06F 13/161; G06F 9/3858

(57) ABSTRACT

An information processing device includes speed-up circuits that execute specific arithmetic operation processing, a CPU that holds a plurality of pieces of transfer data to be transferred to one or a plurality of the speed-up circuits and a plurality of data transfer commands for an instruction to transfer the transfer data to one or a plurality of the speed-up circuits, a plurality of data write circuits that are provided for the respective speed-up circuits, each of which writes the transfer data to the speed-up circuit, a write destination determination circuit that outputs a write instruction signal for an instruction to write the transfer data to the speed-up circuit, to one or a plurality of the data write circuits according to the data transfer command output from the CPU, and a data transfer circuit that transfers the transfer data output from the CPU to each of the data write circuits.

### CLAIM OF PRIORITY

The present application claims priority from Japanese Patent Application JP 2025-058905 filed on Mar. 31, 2025, the content of which is hereby incorporated by reference into this application.

### BACKGROUND OF THE INVENTION

### 1. Field of the Invention

The present invention relates to an information processing device, an information processing system, and an information processing method.

### 2. Description of the Related Art

In control of industrial equipment such as industrial robots and power systems, it is necessary to realize real-time control using inexpensive edge devices such as embedded systems. As a method of speeding up processing in the edge device, use of a graphics processing unit (GPU) is conceivable. However, in complicated processing in the control field, the GPU is not cost-effective, and speed-up based on a central processor unit (CPU) is required. As one of the methods of speeding up the processing based on the CPU, for example, there is a method of speeding up the processing of the entire edge device by providing hardware specialized for specific arithmetic operation processing separately from the CPU in the edge device and causing specific processing to be executed in parallel. Examples of the hardware specialized for the specific arithmetic operation processing include a plurality of circuits, processing units, large scale integration (LSI), and the like (referred to as a speed-up circuit).

For example, JP 2014-48954 A discloses a technique related to speed-up of processing based on a CPU. This publication discloses a data transfer device that “includes a memory that stores data, storage means for storing a data transfer command instructed from a CPU, a plurality of counters in which addresses of the storage means in which the data transfer command corresponding to each of a plurality of programs is stored are set, a DMA device including a plurality of registers that store addresses respectively corresponding to counter identifiers of the plurality of counters, and execution means for executing DMA data transfer between the memory and the DMA device in accordance with the data transfer command stored in the storage means by using the addresses set in the plurality of counters while performing switching between the plurality of counters, based on a data transfer request from the DMA device, and output the counter identifier of the counter that stores an address of the data transfer command to be executed to the DMA device”.

### SUMMARY OF THE INVENTION

In the above technique, for example, state information such as a motor angle and an operating state of a control target device and peripheral information by a camera, a sensor, or the like are acquired, a command value is calculated from these pieces of information, and the command value is converted into a drive format of the control target device such as a pulse, and the control is performed. The acquisition of these pieces of information, the command value calculation, and the control according to the command value are performed by different devices, and the control of the industrial equipment is realized by transmitting and receiving data between these devices. The number of information acquisition devices and control target devices tends to increase. In addition, due to improvement in resolution of acquired information and complication of control contents, data transmitted and received between devices is also increasing. Therefore, a large amount of data processing is required for the edge device. In addition, in a case of deriving an optimum solution of not only individual industrial devices but also the whole of a factory, a facility, or the like provided with a plurality of pieces of industrial equipment, the calculation using a larger amount of data is required in the edge device.

In such edge devices, these large amounts of data are stored in a memory, transferred to a general-purpose arithmetic operational unit or a plurality of speed-up circuits, subjected to arithmetic operation processing by the arithmetic operational unit or each speed-up circuit, and then the processing results are stored in the memory again. Since arithmetic operations for control of industrial equipment require real-time processing, speed-up of processing using not only an arithmetic operational unit but also a plurality of speed-up circuits is being promoted. However, the movement of these large amounts of data between the memory and each speed-up circuit has become a problem as a factor that increases the processing time in the edge device.

In the conventional example as disclosed in JP 2014-48954 A, a data transfer unit can be realized with an interface with one DMA port for data transfer, one DMA device, and one CPU, and simultaneous parallel data transfer according to a plurality of programs can be performed while suppressing an increase in circuit size and wiring. However, since data transfer to each speed-up circuit is processed sequentially, there is a problem that it is not possible to suppress an increase in processing time when a large amount of data is transferred to multiple speed-up circuits.

The present invention has been made in view of the above problems, and an object of the present invention is to provide an information processing device, an information processing system, and an information processing method capable of shortening a data transfer time between a CPU and a plurality of speed-up circuits and suppressing an increase in processing time caused by a large amount of data movement.

The present application includes plurality of means for solving at least a part of the above problems, and an example thereof is as follows. That is, an information processing device includes a plurality of speed-up circuits that execute specific arithmetic operation processing, a CPU that holds a plurality of pieces of transfer data to be transferred to one or a plurality of the speed-up circuits and a plurality of data transfer commands for an instruction to transfer the transfer data to one or a plurality of the speed-up circuits, a plurality of data write circuits that are provided for the respective speed-up circuits, each of which writes the transfer data to the speed-up circuit, a write destination determination circuit that outputs a write instruction signal for an instruction to write the transfer data to the speed-up circuit, to one or a plurality of the data write circuits according to the data transfer command output from the CPU, and a data transfer circuit that transfers the transfer data output from the CPU to each of the data write circuits.

According to the present invention, it is possible to provide an information processing device, an information processing system, and an information processing method capable of shortening a data transfer time between a CPU and a plurality of speed-up circuits and suppressing an increase in processing time caused by a large amount of data movement.

Objects, configurations, and effects other than those described above will be clarified by the descriptions of the following embodiments.

### BRIEF DESCRIPTION OF THE DRAWINGS

FIG. 1 is an example of a functional block diagram of a control apparatus according to a first embodiment;

FIG. 2 is an example of a functional block diagram of an information processing device according to the first embodiment;

FIG. 3 is an example of a functional block diagram of a speed-up circuit according to the first embodiment;

FIG. 4 is a diagram illustrating an example of a configuration of a high-speed arithmetic operation data holding unit according to the first embodiment;

FIG. 5 is an example of a functional block diagram of a memory according to the first embodiment;

FIG. 6 is a diagram illustrating an example of a configuration of a command holding unit according to the first embodiment;

FIG. 7 is a diagram illustrating an example of a configuration of a general-purpose data holding unit according to the first embodiment;

FIG. 8 is a diagram illustrating an example of a configuration of a command code of a data transfer command according to the first embodiment;

FIG. 9 is an example of a functional block diagram of a write destination determination circuit according to the first embodiment;

FIG. 10 is a diagram illustrating an example of a configuration of a write enable signal according to the first embodiment;

FIG. 11 is a flowchart illustrating an example of signal output processing by a write signal output unit according to the first embodiment;

FIG. 12 is a flowchart illustrating an example of transfer processing by a data transfer circuit according to the first embodiment;

FIG. 13 is a flowchart illustrating an example of write processing by a data write circuit according to the first embodiment;

FIG. 14 is a diagram illustrating an example of a configuration of a command holding unit according to a second embodiment;

FIG. 15 is a diagram illustrating an example of a configuration of a general-purpose data holding unit according to the second embodiment;

FIG. 16 is a diagram illustrating an example of a configuration of a command code of a data transfer command according to the second embodiment;

FIG. 17 is a diagram illustrating an example of a configuration of a command code of a group management command according to the second embodiment;

FIG. 18 is an example of a functional block diagram of a write destination determination circuit according to the second embodiment;

FIG. 19 is a diagram illustrating an example of a configuration of group configuration information according to the second embodiment; and

FIG. 20 is a diagram illustrating an example of a configuration of a write enable signal according to the second embodiment.

### DESCRIPTION OF THE PREFERRED EMBODIMENTS

Hereinafter, embodiments of the present invention will be described with reference to the drawings. Embodiments are examples for describing the present invention, and are omitted and simplified as appropriate for clarity of description. The present invention can be implemented in various other forms. Unless otherwise specified, each constituent element may be singular or plural.

Positions, sizes, shapes, ranges, and the like of the constituent elements illustrated in the drawings are provided to facilitate understanding of the invention and may not represent actual positions, sizes, shapes, ranges, and the like. Therefore, the present invention is not necessarily limited to the positions, sizes, shapes, ranges, and the like illustrated in the drawings. In a case where there is a plurality of constituent elements having the same or similar functions, the same reference signs may be denoted with different subscripts for description. In addition, in a case where it is not necessary to distinguish the plurality of constituent elements, the description may be made by omitting the subscript.

In the embodiments, processing performed by executing a program may be described. Here, the computer executes a program by a processor (for example, a CPU and a GPU), and performs processing defined by the program using a storage resource (for example, a memory), an interface device (for example, a communication port), and the like. Therefore, the subject of the processing performed by executing the program may be the processor. Similarly, the subject of the processing performed by executing the program may be a controller, a device, a system, a computer, or a node having the processor.

The subject of the processing performed by executing the program may be an arithmetic operational unit, and may include a dedicated circuit that performs specific processing. Here, the dedicated circuit is, for example, a field programmable gate array (FPGA), an application specific integrated circuit (ASIC), a complex programmable logic device (CPLD), or the like.

The program may be installed on the computer from a program source. The program source may be, for example, a program distribution server or a computer-readable storage medium. In a case where the program source is a program distribution server, the program distribution server may include a processor and a storage resource that stores a distribution target program, and the processor of the program distribution server may distribute the distribution target program to another computer. In the embodiments, two or more programs may be implemented as one program, or one program may be implemented as two or more programs.

### First Embodiment

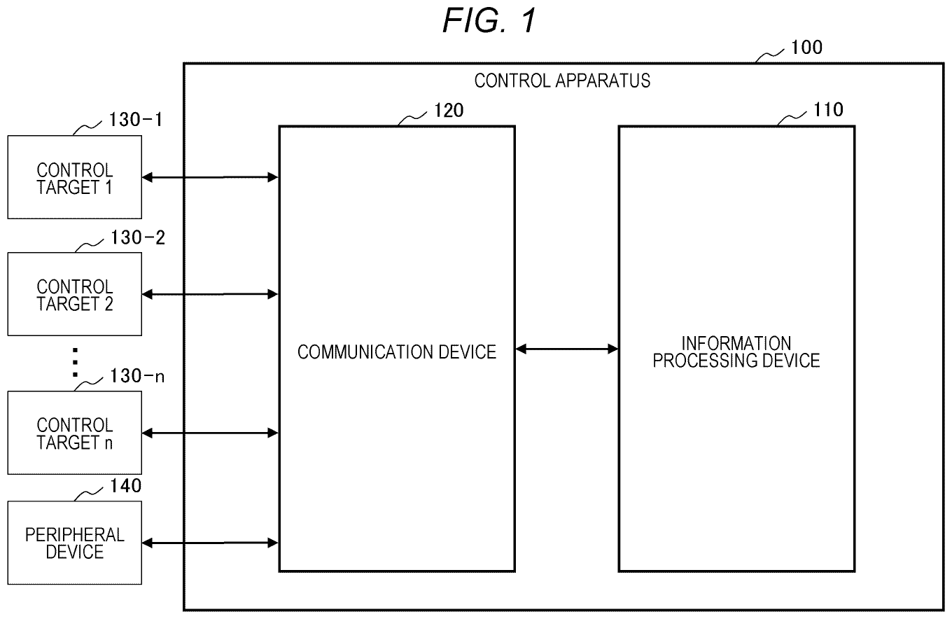

FIG. 1 illustrates an example of a functional block diagram of a control apparatus according to a first embodiment. In FIG. 1, a control apparatus 100 includes, as main configurations, an information processing device 110 responsible for generating control command values and analyzing information based on acquired data, and a communication device 120 that receives data and transmits control command values. The control apparatus 100 controls one or a plurality of control targets 130-1 to 130-n (n is an integer; and the control targets 130-1 to 130-n or one or a plurality of control targets are collectively referred to as control targets 130 below) that are pieces of industrial equipment. The communication device 120 receives various types of data such as state information from the control target 130 and transmits a control command value to the control target 130. The communication device 120 can also transmit and receive various types of data to and from one or a plurality of peripheral devices 140, for example, devices that collect peripheral information, such as sensors and cameras, or devices that generate operation plans for control targets.

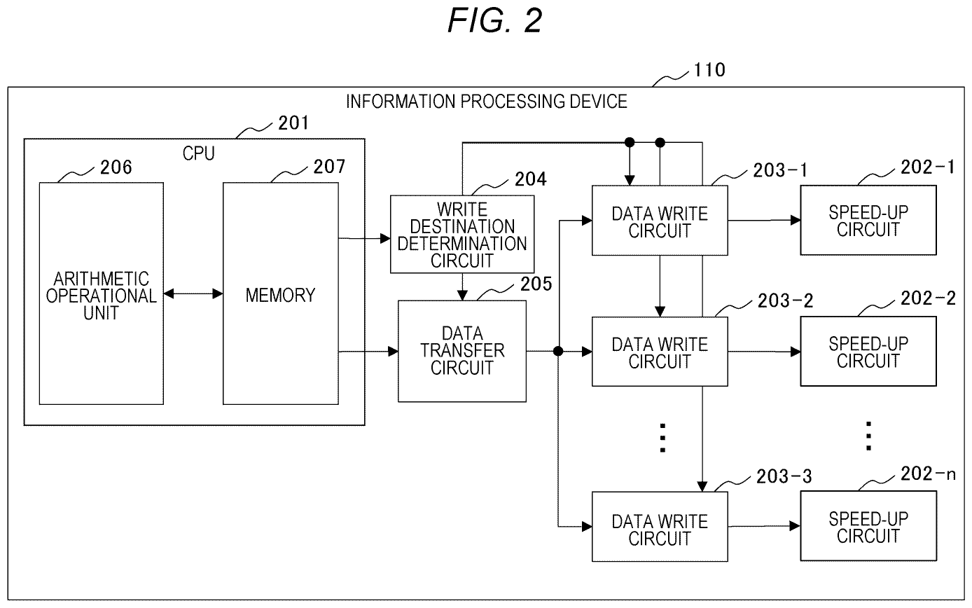

FIG. 2 illustrates an example of a functional block diagram of an information processing device according to the first embodiment. In FIG. 2, an information processing device 110 includes a CPU 201, a plurality of speed-up circuits 202-1 to 202-n, a plurality of data write circuits 203-1 to 203-n, a write destination determination circuit 204, and a data transfer circuit 205.

The CPU 201 holds data and commands and executes arithmetic operation processing. The plurality of speed-up circuits 202-1 to 202-n (the speed-up circuits 202-1 to 202-n or one or a plurality of speed-up circuits are collectively referred to as speed-up circuits 202 below) execute arithmetic operation processing regarding the control targets 130-1 to 130-n in parallel. The plurality of data write circuits 203-1 to 203-n (the data write circuits 203-1 to 203-n or one or a plurality of data write circuits are collectively referred to as data write circuits 203 below) execute writing of data to the speed-up circuits 202-1 to 202-n, respectively. The write destination determination circuit 204 controls write processing of the data write circuits 203-1 to 203-n. The data transfer circuit 205 transfers various types of data held by the CPU 201 to the data write circuits 203-1 to 203-n. The data transfer circuit 205 may simultaneously transfer data to the data write circuits 203-1 to 203-n.

The CPU 201 includes an arithmetic operational unit 206 that executes a plurality of types of arithmetic operations such as four arithmetic operations including addition, subtraction, multiplication, and division, logical operations such as AND and OR, and bit shifts, according to arithmetic operation commands, and a memory 207 that holds data such as common data and target data, data transfer instructions, and arithmetic operation commands, as described later.

The speed-up circuits 202-1 to 202-n can process a large amount of data at a higher speed than the CPU 201 by executing a plurality of types of arithmetic processing in parallel. FIG. 2 illustrates an example in which the information processing device 110 includes the same number of speed-up circuits 202-1 to 202-n as the control targets 130-1 to 130-n. In this case, the speed-up circuits 202-1 to 202-n are provided for the respective control targets 130-1 to 130-n, and each of the speed-up circuits 202-1 to 202-n is configured to execute arithmetic operation processing regarding each of corresponding control targets 130-1 to 130-n. However, the number of speed-up circuits 202 is not limited to this and may be any number such as the number required for parallel processing in the information processing device 110. For example, one or a plurality of speed-up circuits 202 may be provided for each control target 130, or conversely, one speed-up circuit 202 may be provided for a plurality of control targets 130. Alternatively, in a case where the information processing device 110 performs image processing, speed-up circuits 202 may be provided in units of regions of an image as a processing target, which is divided into a plurality of regions, or in units of processing ranges.

The data write circuits 203-1 to 203-n are provided exclusively for the respective speed-up circuits 202-1 to 202-n. As described later, the data write circuits 203-1 to 203-n receive, as inputs, common data or target data transferred from the data transfer circuit 205 and a write instruction signal, and execute writing of the common data or target data input to the corresponding speed-up circuits 202-1 to 202-n, respectively, according to the value of the write instruction signal.

The write destination determination circuit 204 determines to which among the speed-up circuits 202-1 to 202-n data is to be written based on the data transfer command transmitted from the CPU 201, outputs a write instruction signal of 1 bit per circuit to each of the data write circuits 203-1 to 203-n, and outputs a transfer enable signal to the data transfer circuit 205. The data transfer circuit 205 simultaneously transfers the common data or target data transmitted from the CPU 201 to each of the data write circuits 203-1 to 203-n according to the value of the transfer enable signal output from the write destination determination circuit 204.

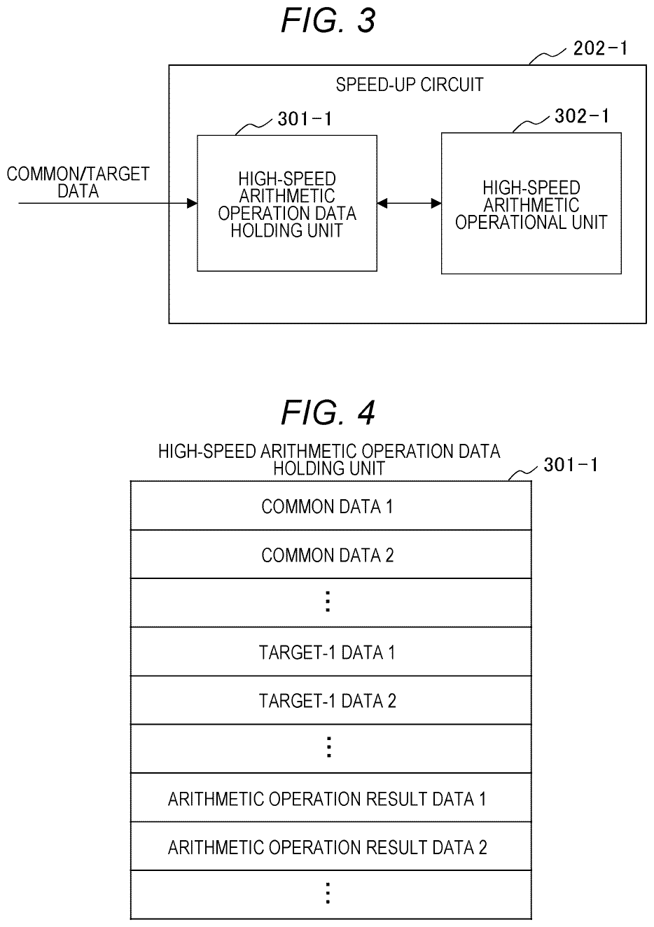

FIG. 3 is an example of a functional block diagram of the speed-up circuit according to the first embodiment. FIG. 3 representatively illustrates the configuration of the speed-up circuit 202-1, and the configurations of the other speed-up circuits 202-2 to 202-n are similar to each other. The speed-up circuit 202 includes a high-speed arithmetic operation data holding unit 301 (FIG. 3 illustrates a high-speed arithmetic operation data holding unit 301-1 as the configuration of the speed-up circuit 202-1) that holds common data and target data written by the dedicated data write circuit 203 and arithmetic operation result data, and a high-speed arithmetic operational unit 302 (FIG. 3 illustrates a high-speed arithmetic operational unit 302-1 as the configuration of the speed-up circuit 202-1) that executes arithmetic operation processing by receiving, as inputs, the common data and target data held by the high-speed arithmetic operation data holding unit 301.

The high-speed arithmetic operational unit 302 executes a plurality of types of arithmetic operation processing such as four arithmetic operations including addition, subtraction, multiplication, and division, logical operations such as AND and OR, and bit shifts. The high-speed arithmetic operational unit 302 may execute arithmetic operation processing according to an arithmetic operation command transmitted from the CPU 201. For example, a dedicated command holding unit may be provided in the speed-up circuit 202-1, and the high-speed arithmetic operational unit 302 may execute arithmetic operation processing according to an arithmetic operation command read therefrom, determine a processing operation according to information or a command input from the outside of the information processing device 110, or constantly execute predetermined arithmetic operations.

FIG. 4 is a diagram illustrating an example of a configuration of the high-speed arithmetic operation data holding unit according to the first embodiment. FIG. 4 representatively illustrates the configuration of the high-speed arithmetic operation data holding unit 301-1 provided in the speed-up circuit 202-1, and the configurations of the other high-speed arithmetic operation data holding units 301-2 to 301-n are similar to each other. The high-speed arithmetic operation data holding unit 301 holds a plurality of pieces of common data commonly used for arithmetic operation processing in all speed-up circuits 202, a plurality of pieces of target data used for arithmetic operation processing only in the speed-up circuit 202 to which the high-speed arithmetic operation data holding unit 301 belongs, and a plurality of pieces of arithmetic operation result data from the high-speed arithmetic operational unit 302.

The common data is, for example, peripheral information that has been input from the peripheral device 140 and collected by cameras, sensors, and the like, information such as an overall plan transmitted from a data center or a server, or state information of the control apparatus 100. The target data is information unique to the control target 130, such as the state and operation plan of each control target 130.

The high-speed arithmetic operation data holding unit 301 holds only target data regarding the control target 130 supported by the speed-up circuit 202 to which the high-speed arithmetic operation data holding unit 301 belongs. For example, in the example illustrated in FIG. 4, the high-speed arithmetic operation data holding unit 301-1 belonging to the speed-up circuit 202-1 holds only target data regarding the control target 130-1 supported by the speed-up circuit 202-1 (FIG. 4 illustrates target-1 data, and target data regarding each of the control targets 130-1 to 130-n is referred to as target-1 data to target-n data below, respectively).

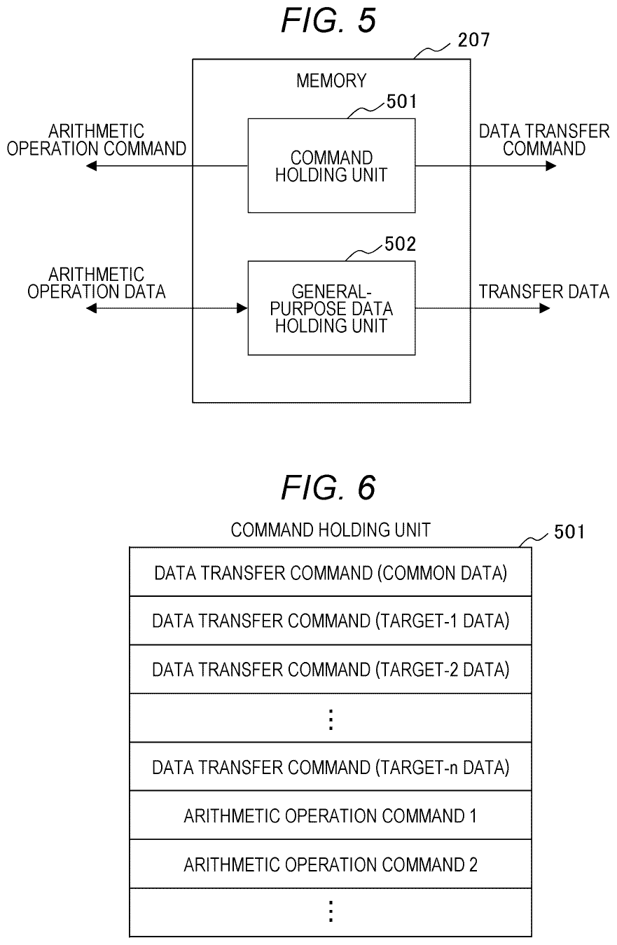

FIG. 5 is an example of a functional block diagram of the memory according to the first embodiment. The memory 207 includes a command holding unit 501 that holds various commands such as arithmetic operation commands and data transfer commands, and a general-purpose data holding unit 502 that holds CPU arithmetic operation data used for arithmetic operations by the arithmetic operational unit 206, and common data and target data, which are to be transferred to the speed-up circuits 202-1 to 202-n. The command holding unit 501 transmits an arithmetic operation command to the arithmetic operational unit 206 and transmits data transfer commands to the write destination determination circuit 204 and the data transfer circuit 205. The general-purpose data holding unit 502 transmits CPU arithmetic operation data to the arithmetic operational unit 206, receives and holds arithmetic operation result data from the arithmetic operational unit 206, and transmits common data and target data to the data transfer circuit 205 (common data and target data, which are transmitted from the general-purpose data holding unit 502 to the data transfer circuit 205 and transferred from the data transfer circuit 205 to each of the data write circuits 203-1 to 203-n, are collectively referred to as transfer data below).

FIG. 6 is a diagram illustrating an example of a configuration of the command holding unit according to the first embodiment. The command holding unit 501 holds a plurality of data transfer commands and arithmetic operation commands, respectively. Although FIG. 6 illustrates only data transfer commands and arithmetic operation commands, the command holding unit 501 may hold various other commands. As the data transfer command, there are a common data transfer command and a target data transfer command. The common data transfer command is a command to issue an instruction to transfer the same common data to all speed-up circuits 202-1 to 202-n. The target data transfer command is a command to designate one of the speed-up circuits 202-1 to 202-n and issue an instruction to transfer target data to the designated speed-up circuit 202. The arithmetic operation command is a command to instruct various types of arithmetic operation processing to the arithmetic operational unit 206. Further, as described above, the command holding unit 501 may hold an arithmetic operation command for the high-speed arithmetic operational unit 302 in each speed-up circuit 202 and transmit the arithmetic operation command to each high-speed arithmetic operational unit 302.

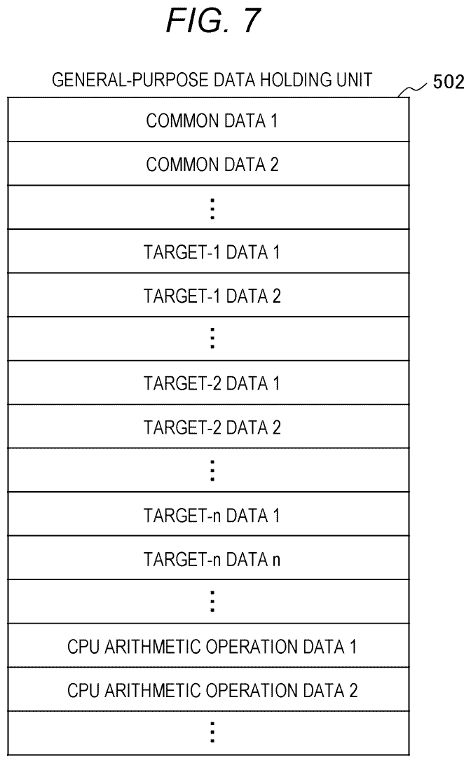

FIG. 7 is a diagram illustrating an example of a configuration of the general-purpose data holding unit according to the first embodiment. The general-purpose data holding unit 502 holds a plurality of pieces of common data, a plurality of pieces of target data regarding each control target 130 (a plurality of pieces of target-1 data to target-n data, respectively), and a plurality of pieces of CPU arithmetic operation data. The common data and target data are similar to the common data and target data held by the high-speed arithmetic operation data holding unit 301, as described in the description with reference to FIG. 4.

The common data is transferred to all speed-up circuits 202 and written to each high-speed arithmetic operation data holding unit 301. The target data is individually transferred to the speed-up circuit 202 corresponding to the control target 130 according to which the data relates to among the control targets 130-1 to 130-n, and written to the high-speed arithmetic operation data holding unit 301. The CPU arithmetic operation data is data that is input to the arithmetic operational unit 206 and used for arithmetic operations, and arithmetic operation result data output by the arithmetic operational unit 206.

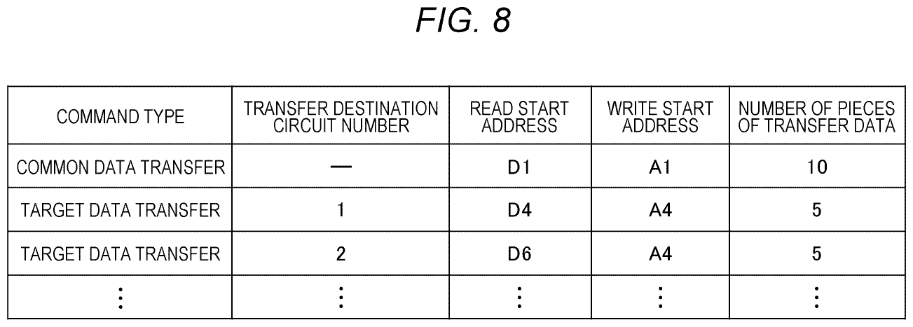

FIG. 8 is a diagram illustrating an example of a configuration of a command code of a data transfer command held by the command holding unit according to the first embodiment. As illustrated in FIG. 8, the command code of the data transfer command is configured by a command type, a transfer destination circuit number, a read start address, a write start address, and the number of pieces of transfer data.

The command type indicates the type of data transfer command, and, in the example illustrated in FIG. 8, there are two types: common data transfer and target data transfer, depending on the type of transfer data. Common data transfer and target data transfer are as described in the description with reference to FIG. 6.

The transfer destination circuit number specifies to which the target data is to be transferred among the speed-up circuits 202-1 to 202-n in a case where the command type indicates target data transfer. In the present embodiment, mutually different circuit numbers 1 to n are assigned in advance to the respective speed-up circuits 202-1 to 202-n, and one of those circuit numbers is designated as the transfer destination circuit number.

The read start address indicates an address of the general-purpose data holding unit 502 in the memory 207 and designates the leading address of a storage location of the transfer data. The write start address indicates an address of the high-speed arithmetic operation data holding unit 301 in the speed-up circuit 202 and designates the leading address of a storage location of the transfer data. The write start address is a relative address indicating a position from the leading address of the high-speed arithmetic operation data holding unit 301, and can be commonly used for each high-speed arithmetic operation data holding unit 301 of each speed-up circuit 202.

Regarding the number of pieces of transfer data, the size of data that can be transferred per one operation (this operation is referred to as a cycle) in which the data transfer circuit 205 transfers transfer data read from the memory 207 to each of the data write circuits 203-1 to 203-n, that is, in one cycle (referred to as transferable data size below), is predetermined. In a case where the data size of the transfer data is larger than the transferable data size, the data transfer circuit 205 repeats the cycle consecutively a plurality of times, that is, performs data transfer over a plurality of cycles. Therefore, in the example illustrated in FIG. 8, one cycle of data transfer by the data transfer circuit 205 is expressed as Data number 1, and the number of data transfer cycles according to the data size of the transfer data is designated as the number of pieces of transfer data.

For example, if the data size of the transfer data is equal to or less than the transferable data size, the number of pieces of transfer data is “1” because the transfer data can be transferred in one cycle. Similarly, if the data size of the data to be transferred is equal to or less than twice the transferable data size, the number of pieces of transfer data is “2” because two cycles are required for data transfer, and the number of pieces of transfer data is “x” if the data size of the data to be transferred is equal to or less than x times the transferable data size.

In addition, as the number of pieces of transfer data, the data size of the transfer data may be designated by the number of bytes or the like in addition to the above description.

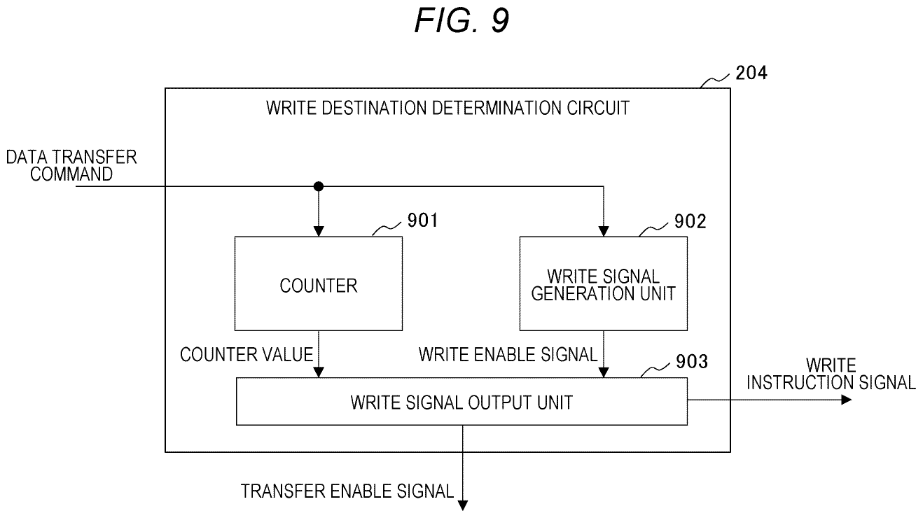

FIG. 9 illustrates an example of a functional block diagram of the write destination determination circuit according to the first embodiment. The write destination determination circuit 204 includes a counter 901, a write signal generation unit 902, and a write signal output unit 903.

The counter 901 performs counting based on the number of cycles of data transfer and outputs a counter value to the write signal output unit 903. First, the counter 901 calculates the number of cycles of data transfer based on information of the number of pieces of transfer data in the data transfer command transmitted from the command holding unit 501. For example, as in the example illustrated in FIG. 8, in a case where the number of pieces of transfer data is designated in a format indicating the number of cycles of data transfer based on the transferable data size, the counter 901 uses the value of the number of pieces of transfer data as it is as the number of cycles. Furthermore, in a case where the number of pieces of transfer data is designated in a format indicating the data size of transfer data such as the number of bytes, the counter 901 calculates the number of cycles based on the transferable data size using the number of pieces of transfer data, that is, the data size.

Then, the counter 901 sets an initial value for counting and starts counting. The counter 901 is, for example, an addition/subtraction counter, and can count down by using the number of cycles calculated as described above as the initial value for counting, or conversely, can count up with the initial value for the counting as “1”. The counter 901 performs counting, that is, counts up or counts down, for example, every time the counter 901 outputs a counter value to the write signal output unit 903.

The write signal generation unit 902 receives the data transfer command as an input, generates a write enable signal for enabling or disabling writing of data by each data write circuit 203, and outputs the generated signal to the write signal output unit 903.

The write signal output unit 903 receives the counter value from the counter 901 and the write enable signal from the write signal generation unit 902 as inputs, transmits a write instruction signal to each of the data write circuits 203-1 to 203-n, and transmits a transfer enable signal to the data transfer circuit 205.

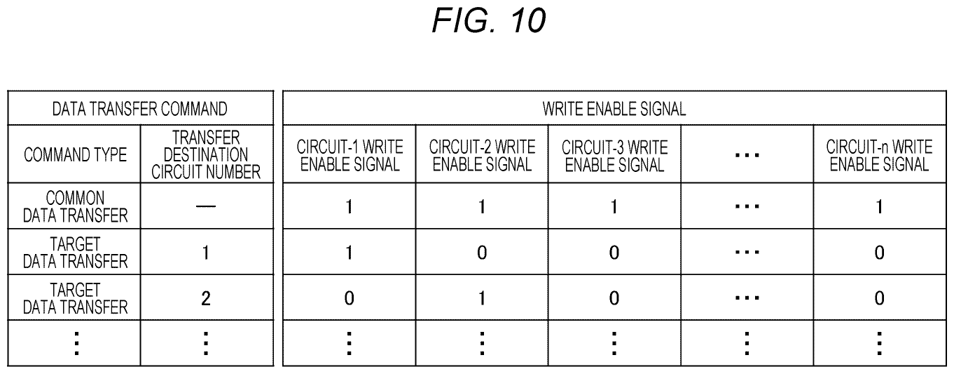

FIG. 10 is a diagram illustrating an example of a configuration of the write enable signal generated by the write signal generation unit according to the first embodiment. FIG. 10 also illustrates the data transfer command input to the write signal generation unit 902.

The write signal generation unit 902 receives the command type and transfer destination circuit number in the data transfer command as inputs and generates a write enable signal. The write enable signal includes a circuit write enable signal of 1 bit per set for the number of sets (that is, n sets) of each speed-up circuit 202 and each dedicated data write circuit 203 (for example, a set of the speed-up circuit 202-1 and the data write circuit 203-1). In FIG. 10, for example, the circuit write enable signal for the set of the speed-up circuit 202-1 and the data write circuit 203-1 is expressed as a circuit-1 write enable signal, and the write enable signal includes a circuit-1 write enable signal to a circuit-n write enable signal.

In a case where the command type indicates common data transfer, the write signal generation unit 902 sets all circuit write enable signals to “1” regardless of the value of the transfer destination circuit number, and generates a write enable signal. For example, in the example of the first write enable signal in FIG. 10, since the command type indicates common data transfer, all of the circuit-1 write enable signal to the circuit-n write enable signal are set to “1”.

In a case where the command type indicates target data transfer, the write signal generation unit 902 sets the circuit write enable signal for the set corresponding to one of the speed-up circuits 202-1 to 202-n, which has been designated by the transfer destination circuit number, to “1”, and sets the other circuit write enable signals to “0”, and thereby generating the write enable signal.

For example, in the example of the second write enable signal in FIG. 10, since the command type indicates target data transfer and the transfer destination circuit number is “1”, the circuit-1 write enable signal for the set of the speed-up circuit 202-1 and the data write circuit 203-1 whose circuit number is “1” is set to “1”, and the other the circuit-2 write enable signal to the circuit-n write enable signal are all set to “0”.

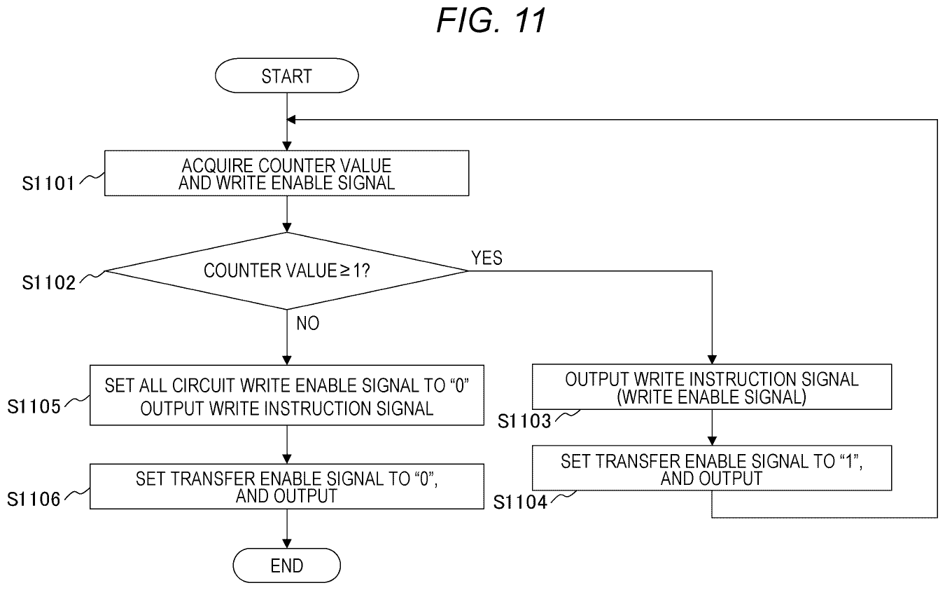

FIG. 11 is a flowchart illustrating an example of signal output processing by the write signal output unit according to the first embodiment. As a premise, it is assumed that the counter 901 sets the calculated number of cycles to the initial value for the counting and performs output of the counter value and counting down.

In S1101, the write signal output unit 903 acquires the counter value output by the counter 901 and the write enable signal output by the write signal generation unit 902. In S1102, the write signal output unit 903 determines whether or not the counter value is equal to or more than “1”. In a case where the counter value is equal to or more than “1”, in S1103, the write signal output unit 903 outputs the acquired write enable signal to each data write circuit 203 as a write instruction signal. Since the write instruction signal has the similar configuration to the write enable signal illustrated in FIG. 10, the write signal output unit 903 can use (output) the write enable signal as it is as the write instruction signal.

Subsequently, in S1104, the write signal output unit 903 sets the transfer enable signal to “1” and outputs the transfer enable signal to the data transfer circuit 205. Thereafter, the write signal output unit 903 returns to the process of S1101 and repeats the processes of S1101 to S1104 while the counter value is equal to or more than “1”.

In a case where it is determined in S1102 that the counter value is less than “1”, in S1105, the write signal output unit 903 sets all circuit write enable signals in the write instruction signal to “0” and outputs all the circuit write enable signals to the data write circuits 203. Then, in S1106, the write signal output unit 903 sets the transfer enable signal to “0” and outputs the transfer enable signal to the data transfer circuit 205, and ends the signal output processing.

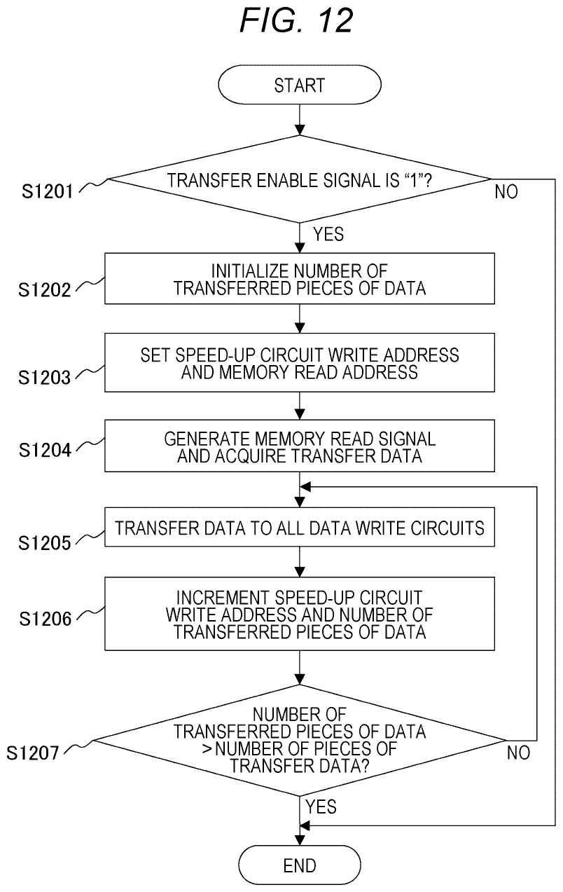

FIG. 12 is a flowchart illustrating an example of transfer processing by the data transfer circuit according to the first embodiment. As a premise, the data transfer circuit 205 includes at least a register for temporarily holding transfer data, a register for counting the number of transferred pieces of data (or data amount), a register for setting a speed-up circuit write address, and a register for setting a memory read address.

In S1201, the data transfer circuit 205 determines whether or not the transfer enable signal transmitted from the write signal output unit 903 in the write destination determination circuit 204 is “1”. In a case where the transfer enable signal is “0”, the data transfer circuit 205 ends the transfer processing. In a case where the transfer enable signal is “1”, in S1202, the data transfer circuit 205 initializes the number of transferred pieces of data, that is, sets the value of the register for counting the number of transferred pieces of data to “0”. In S1203, the data transfer circuit 205 sets the speed-up circuit write address and the memory read address in the respective registers based on the data transfer command transmitted from the command holding unit 501 in the memory 207. The speed-up circuit write address uses the write start address in the data transfer command. The memory read address uses the read start address in the data transfer command.

In S1204, the data transfer circuit 205 generates a memory read signal and then transmits the memory read signal to the memory 207 together with the memory read address. The memory 207 outputs the transfer data stored at the memory read address in response to the memory read signal. As a result, the data transfer circuit 205 acquires the transfer data from the memory 207 and stores the transfer data in the register. In S1205, the data transfer circuit 205 transfers the transfer data and the speed-up circuit write address to all data write circuits 203. At this time, since the data transfer circuit 205 transfers the same data, it is not necessary to sequentially transmit the transfer data to each data write circuit 203, and it may be simultaneously transmitted to all data write circuits 203. S1205 is one cycle of data transfer, and what the data transfer circuit 205 transfers in S1205 is data for the transferable data size among pieces of the transfer data.

When the data transfer corresponding to the transferable data size is completed, in S1206, the data transfer circuit 205 increments the speed-up circuit write address set in the register, by the transferable data size. In addition, in a case where the number of pieces of transfer data in the data transfer command transmitted from the command holding unit 501 is designated in a format indicating the number of cycles of data transfer, the data transfer circuit 205 increments (+1) the number of transferred pieces of data. On the other hand, in a case where the number of pieces of transfer data is designated in a format indicating the data size of the transfer data such as the number of bytes, the data transfer circuit 205 increments the number of transferred pieces of data by the transferable data size.

Subsequently, in S1207, the data transfer circuit 205 compares the number of pieces of transfer data with the number of transferred pieces of data, and determines whether or not the number of transferred pieces of data is more than the number of pieces of transfer data. In a case where the number of transferred pieces of data is less than the number of pieces of transfer data, the data transfer circuit 205 returns to the process of S1205 and repeats the processes of S1205 to S1207 while the number of transferred pieces of data is less than the number of pieces of transfer data.

In a case where it is determined in S1207 that the number of transferred pieces of data is more than the number of pieces of transfer data, that is, in a case where the transfer of transfer data has completed, the data transfer circuit 205 ends the transfer processing.

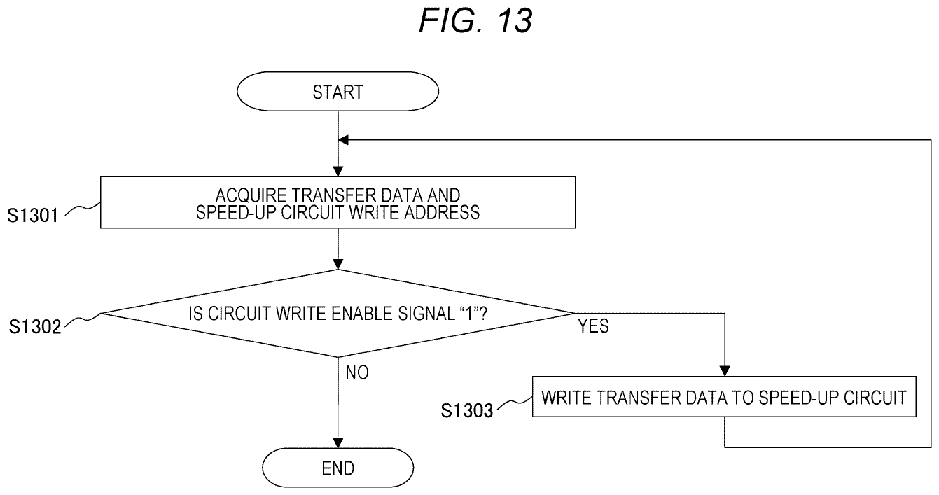

FIG. 13 is a flowchart illustrating an example of write processing by the data write circuit according to the first embodiment. All the data write circuits 203-1 to 203-n execute write processing according to this flowchart.

In S1301, the data write circuit 203 acquires the transfer data and the speed-up circuit write address transmitted from the data transfer circuit 205. What the data write circuit 203 acquires in S1301 is data for the transferable data size among pieces of original transfer data. In S1302, the data write circuit 203 determines whether or not the circuit write enable signal for itself (the set of its own data write circuit and the corresponding speed-up circuit) in the write instruction signal transmitted from the write signal output unit 903 in the write destination determination circuit 204 is “1”. In a case where the circuit write enable signal is “1”, in S1303, the data write circuit 203 executes writing of the acquired data, by the transferable data size, to the high-speed operation arithmetic data holding unit 301 in the corresponding speed-up circuit 202 by using the acquired speed-up circuit write address.

Thereafter, the data write circuit 203 returns to the process of S1301 and repeats the processes of S1301 to S1303 while the circuit write enable signal for the data write circuit 203 is “1”. In S1302, in a case where the circuit write enable signal is “0”, that is, in a case where writing of all pieces of the transfer data has completed, the data write circuit 203 ends the write processing.

As described above, according to the information processing device in the first embodiment, the device includes the data transfer circuit and the write destination determination circuit, and the data transfer circuit transfers transfer data to all data write circuits, for example, simultaneously, and writing of data to each speed-up circuit by each data write circuit is controlled by the write instruction signal transmitted from the write destination determination circuit. As a result, it is not necessary to sequentially transfer data between the CPU and the plurality of speed-up circuits, and it is possible to significantly shorten the data transfer time. Thus, it is possible to suppress an increase in processing time caused by large-scale data movement between the CPU and the plurality of speed-up circuits. Further, a plurality of data transfer circuits are not required for transfer of transfer data, and it is possible to suppress an increase in the physical quantity of the information processing device.

### Second Embodiment

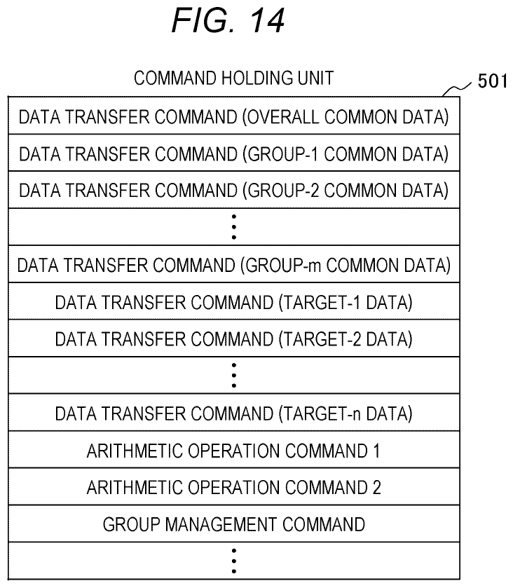

In the first embodiment, an example in which the write destination determination circuit and the data transfer circuit in the information processing device transfer the same common data to all the speed-up circuits according to the common data transfer command has been described. However, for example, the information processing device can be configured such that at least two or more speed-up circuits are regarded as one group and the same common data is transferred to that group. In a second embodiment, an example of an information processing device having such a configuration will be described. The information processing device according to the second embodiment has the similar configuration to the information processing device 110 according to the first embodiment illustrated in FIG. 2. The configurations or contents of commands and data held by the command holding unit and the general-purpose data holding unit are partially different, and the configuration or function of the write destination determination circuit is also partially different. Thus, in FIGS. 14 to 20 to be described below, the same components as those of the information processing device 110 illustrated in FIGS. 2 to 13 and the components are denoted by the same reference signs. In the following description, the description of the contents overlapping with the first embodiment will be omitted, and different parts will be described.

FIG. 14 is a diagram illustrating an example of a configuration of a command holding unit according to the second embodiment. In the second embodiment, a command holding unit 501 holds a plurality of data transfer commands, arithmetic operation commands, and group management commands, respectively. Although FIG. 14 illustrates only data transfer commands, arithmetic operation commands, and group management commands, the command holding unit 501 may hold various other commands.

The data transfer commands held by the command holding unit 501 include an overall common data transfer command, a target data transfer command, and a group common data transfer command. The target data transfer command is the same command as the target data transfer command described in the first embodiment. The overall common data transfer command is a command similar to the common data transfer command described in the first embodiment, and is a command to issue an instruction to transfer the same common data to all speed-up circuits 202-1 to 202-n. On the other hand, the group common data transfer command is a command to designate one group configured by at least two or more (but not all) speed-up circuits 202 and transfer the same group common data to all speed-up circuits 202 included in the designated group.

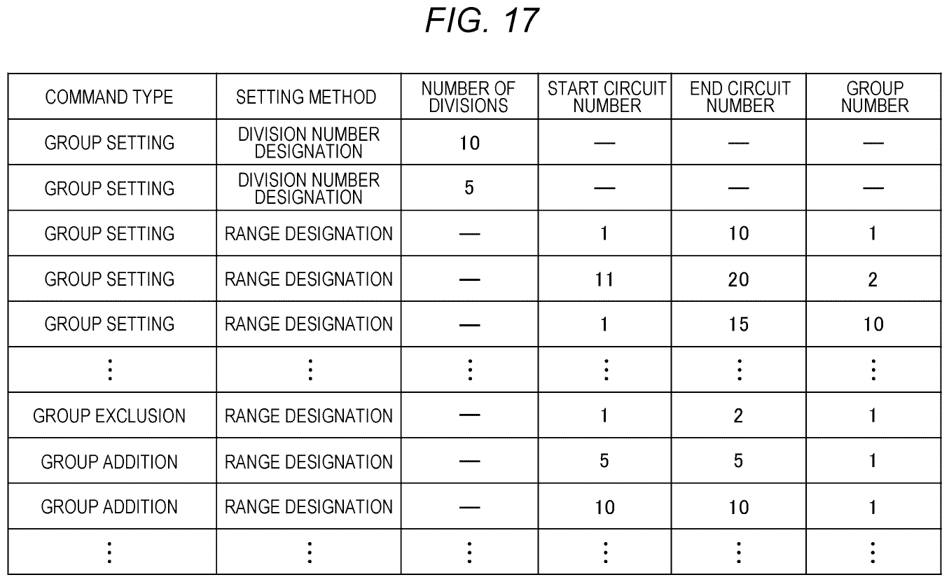

The arithmetic operation command is the same as the arithmetic operation command described in the first embodiment, and the group management command is a command to instruct the group configuration of the speed-up circuits 202-1 to 202-n. The group management command will be described later with reference to FIG. 17.

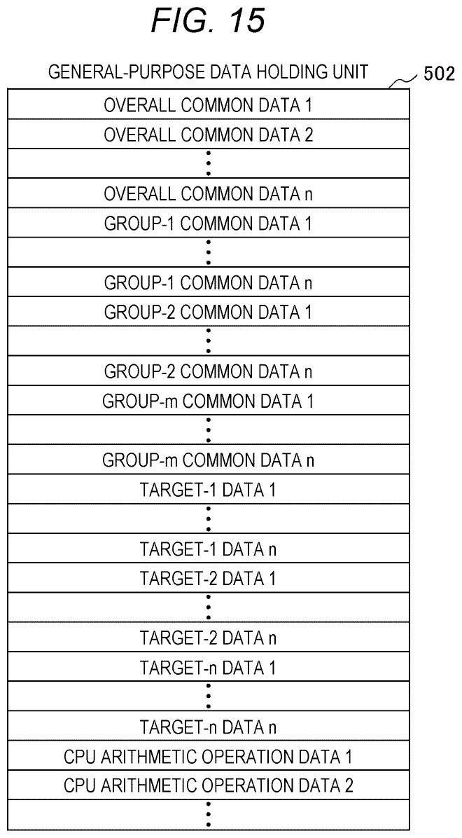

FIG. 15 is a diagram illustrating an example of a configuration of a general-purpose data holding unit according to the second embodiment. In the second embodiment, a general-purpose data holding unit 502 holds each of a plurality of pieces of overall common data, target data, CPU arithmetic operation data, and group common data. The target data and the CPU arithmetic operation data are the same as the target data and the CPU arithmetic operation data, which have been described in the first embodiment. The overall common data is also the same as the common data described in the first embodiment. On the other hand, the group common data is data commonly used for arithmetic operation processing in two or more speed-up circuits included in the same group, and is, for example, common information regarding two or more control targets 130 having the same attributes such as the type and the disposition location.

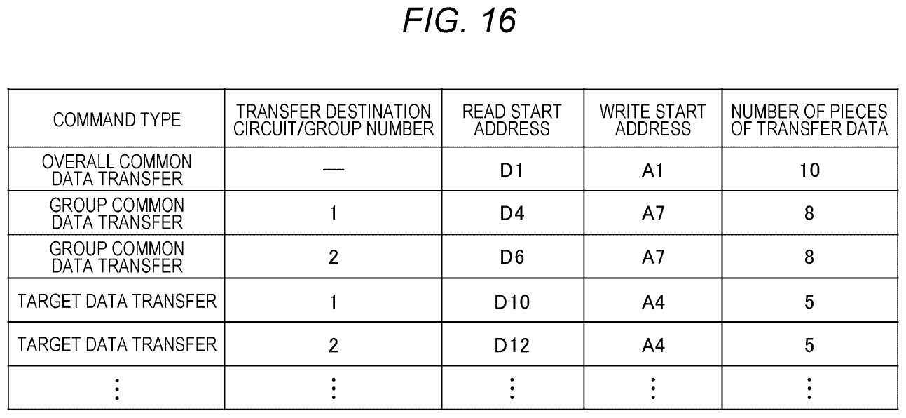

FIG. 16 is a diagram illustrating an example of a configuration of a command code of a data transfer command according to the second embodiment. The configuration of the command code is substantially similar to the configuration of the command code according to the first embodiment illustrated in FIG. 8. However, the transfer destination circuit number illustrated in FIG. 8 is a transfer destination circuit/group number in FIG. 16. In a case where the command type indicates group common data transfer, instead of the transfer destination circuit number, a transfer destination group number, that is, to which group among one or a plurality of groups set in the speed-up circuits 202-1 to 202-n the group common data is to be transferred is designated.

FIG. 17 is a diagram illustrating an example of a configuration of a command code of a group management command according to the second embodiment. The command code of the group management command is configured by a command type, a setting method, a division number, a start point circuit number, an end point circuit number, and a group number.

The command type indicates the type of group management command, and, in the example illustrated in FIG. 17, there are three types: group setting, group exclusion, and group addition. The group setting is a command to designate any two or more speed-up circuits 202 and newly set a group, and group exclusion and group addition will be described later.

The setting method indicates how to designate two or more speed-up circuits 202 constituting a group, and there are two types of setting methods: division number designation and range designation. The division number indicates a specific number of divisions in a case where the setting method indicates the division number designation, and is indicated by an integer of 2 or more.

The division number designation and the division number will be specifically described. In a case where the setting method indicates the division number designation, sets of each speed-up circuit 202 and each data write circuit 203 (for example, a set of the speed-up circuit 202-1 and the data write circuit 203-1, a set of the speed-up circuit 202-2 and the data write circuit 203-2, and the like; description will be made below on the assumption that the set of the speed-up circuit 202-1 and the data write circuit 203-1 is Circuit 1, the set of the speed-up circuit 202-2 and the data write circuit 203-2 is Circuit 2, and the like) are grouped by the division number from the leading. For example, in a case where the division number is 10, groups are set such that Circuits 1 to 10 are Group 1, Circuits 11 to 20 are Group 2, Circuits 21 to 30 are Group 3, and the like. In a case where there is a fraction where the number of circuits does not satisfy the division number, the remaining circuits of which the number is less than the division number are collectively set as one group. In a case where the setting method indicates the division number designation, the respective pieces of information of the start point circuit number, the end point circuit number, and the group number included in the command code are not used in the group setting.

Returning to the description with reference to FIG. 17, the start point circuit number and the end point circuit number in the command code designate one of the circuit numbers assigned to the respective speed-up circuits 202. In a case where the setting method indicates the range designation, a range of two or more speed-up circuits 202 constituting a group is designated by the start point circuit number and the end point circuit number, that is, a range of two or more circuits among Circuits 1 to n that are sets of the speed-up circuits 202 and the data write circuits 203 is designated.

The group number in the command code indicates a number assigned to a group to be set in a case where the command type indicates the group setting. Specifically, in a case where the setting method indicates the range designation, a group is set for two or more speed-up circuits 202 included in the range indicated by the start point circuit number and the end point circuit number, and the number designated by the group number is assigned to that group.

For example, in the example of the third group management command in FIG. 17, the command type indicates the group setting, the setting method indicates the range designation, the start point circuit number is designated as 1, the end point circuit number is designated as 10, and the group number is designated as 1. Therefore, a group is set for Circuits 1 to 10, which are sets of the speed-up circuits 202-1 to 202-10 and the data write circuits 203-1 to 203-10, to which circuit numbers 1 to 10 are assigned, and the group number 1 is assigned (Circuits 1 to 10 are handled as Group 1). Similarly, in the example of the fourth group management command in FIG. 17, the command type indicates the group setting, the setting method indicates the range designation, the start point circuit number is designated as 11, the end point circuit number is designated as 20, and the group number is designated as 2. Therefore, a group is set for Circuits 11 to 20, which are sets of the speed-up circuits 202-11 to 202-20 and the data write circuits 203-11 to 203-20, to which circuit numbers 11 to 20 are assigned, and the group number 2 is assigned (Circuits 11 to 20 are handled as Group 2).

In addition, each of Circuits 1 to n may belong to (be included in) a plurality of groups. For example, in the example of the fifth group management command in FIG. 17, the command type indicates the group setting, the setting method indicates the range designation, the start point circuit number is designated as 1, the end point circuit number is designated as 15, and the group number is designated as 10. Therefore, a group is set for Circuits 1 to 15, which are sets of the speed-up circuits 202-1 to 202-15 and the data write circuits 203-1 to 203-15, to which circuit numbers 1 to 15 are assigned, and the group number 10 is assigned (Circuits 1 to 15 are handled as Group 10). However, as described above, since Circuits 1 to 10 already belong to Group 1 by the third group management command in FIG. 17, Circuits 1 to 10 belong to (are included in) both Group 1 and Group 10.

Further, although the third to fifth group management commands in FIG. 17 show examples of group management commands for designating (grouping) the speed-up circuits 202 with continuous circuit numbers by the start point circuit number and the end point circuit number, it is also possible to set a group by designating the speed-up circuits 202 with discontinuous circuit numbers. In order to designate such speed-up circuits 202 with discontinuous circuit numbers, a command to designate speed-up circuits 202 belonging to a group by excluding the speed-up circuits 202 other than the designated circuit numbers from an existing group as shown in the seventh group management command in FIG. 17, and a command to designate circuit numbers of speed-up circuits 202 to be additionally belonged to an existing group while leaving the existing group setting as shown in the eighth and ninth group management commands in FIG. 17 are used.

Specifically, for example, in the example of the seventh group management command in FIG. 17, the command type indicates the group exclusion, the setting method indicates the range designation, the start point circuit number is designated as 1, the end point circuit number is designated as 2, and the group number is designated as 1. As a premise, assuming that Circuits 1 to 10 are set in Group 1 by the third group management command in FIG. 17, from this group exclusion command, Circuits 3 to 10 other than Circuits 1 and 2 that are sets of the speed-up circuits 202-1 and 202-2 and the data write circuits 203-1 and 203-2 to which the range-designated circuit numbers 1 and 2 are assigned, are excluded from Group 1, and Group 1 is configured by only Circuits 1 and 2.

Subsequently, in the example of the eighth group management command in FIG. 17, the command type indicates the group addition, the setting method indicates the range designation, the start point circuit number is designated as 5, the end point circuit number is designated as 5, and the group number is designated as 1. As described above, assuming that Group 1 is configured by only Circuits 1 and 2 by the seventh group exclusion command, Circuit 5 that is a set of the speed-up circuit 202-5 and the data write circuit 203-5, to which the range-designated circuit number 5 is assigned, is added to Group 1 by this group addition command, and Group 1 is configured by Circuits 1, 2, and 5. Similarly regarding the ninth group management command, Circuit 10 that is a set of the speed-up circuit 202-10 and the data write circuit 203-10, to which the range-designated circuit number 10 is assigned, is added to Group 1, and Group 1 is configured by Circuits 1, 2, 5, and 10.

As described above, by using the group setting command, the group exclusion command, and the group addition command, it becomes possible to set a group by designating the speed-up circuits 202 with discontinuous circuit numbers. The above group exclusion command and group addition command are examples. For example, the group exclusion command may be a command to issue an instruction to exclude the speed-up circuit 202 with a designated circuit number from a group. Further, the group exclusion command and the group addition command may be commands to issue an instruction to exclude and add the speed-up circuits 202 with two circuit numbers which have been individually designated by the start point circuit number and the end point circuit number. Alternatively, a group management command of a type other than the group exclusion or the group addition may be prepared.

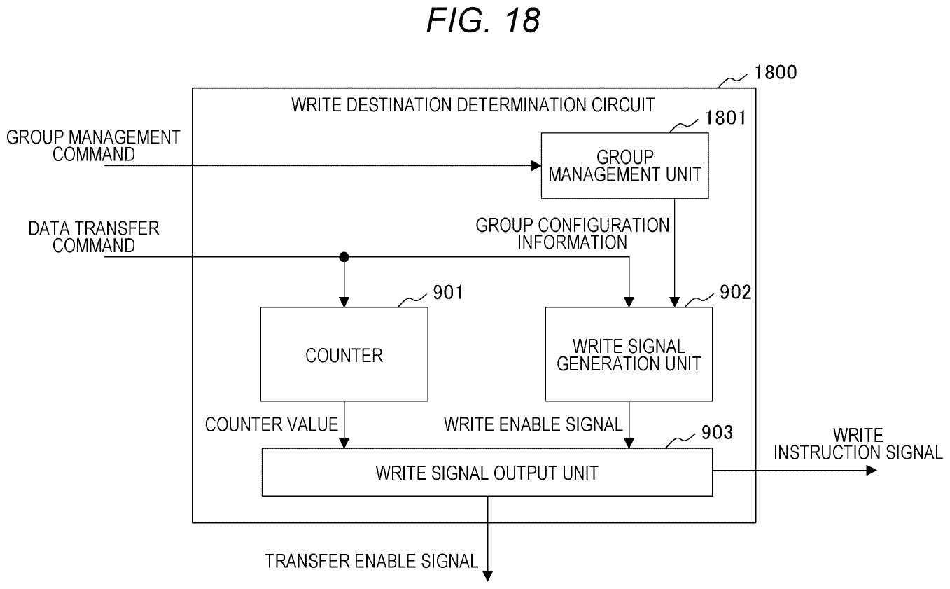

FIG. 18 is an example of a functional block diagram of a write destination determination circuit according to the second embodiment. In FIG. 18, a write destination determination circuit 1800 includes a counter 901, a write signal generation unit 902, and a write signal output unit 903, similarly to the write destination determination circuit 204 illustrated in FIG. 9, and additionally includes a group management unit 1801. The group management unit 1801 generates, holds, and updates configuration information of a group (referred to as group configuration information below) set for Circuits 1 to n, which are sets of the speed-up circuits 202 and the data write circuits 203, according to the group management command transmitted from the command holding unit 501.

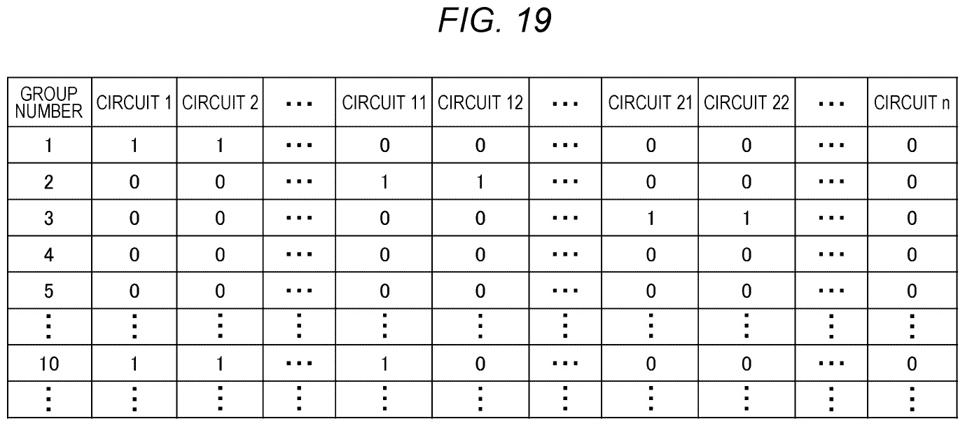

FIG. 19 is a diagram illustrating an example of the group configuration information held by the group management unit according to the second embodiment. The group configuration information held by the group management unit 1801 is information indicating which of Circuits 1 to n belongs to (is included in) each group, and specifically, includes a group number and 1-bit data for each of Circuits 1 to n. The 1-bit data for each circuit indicates whether each of Circuits 1 to n belongs to each group, by being set to “1” in a case where the circuit belongs to the group indicated by the group number, and being set to “0” in a case where the circuit does not belong to the group. For example, in the example of the seventh group configuration information in FIG. 19, it is shown that the group number is 10, each piece of 1-bit data for Circuits 1 to 11 is “1”, and each piece of other 1-bit data is “0”, and Circuits 1 to 11 belong to Group 10.

In a case where the group management command transmitted from the command holding unit 501 is input, the group management unit 1801 generates or updates the group configuration information according to the content of the group management command. As described above, in the example of the group configuration information illustrated in FIG. 19, each piece of 1-bit data (total n-bit data) equal to the number of Circuits 1 to n is required for management of one group. However, in a case where each group is set only for a set of the speed-up circuits 202 and the data write circuits 203 with continuous circuit numbers, the group configuration information may be configured to include only data indicating the start point circuit number and the end point circuit number, like the range designation in the command code of the group management command. As a result, the data amount of the group configuration information is reduced, and it becomes possible to suppress the circuit scale of the group management unit 1801.

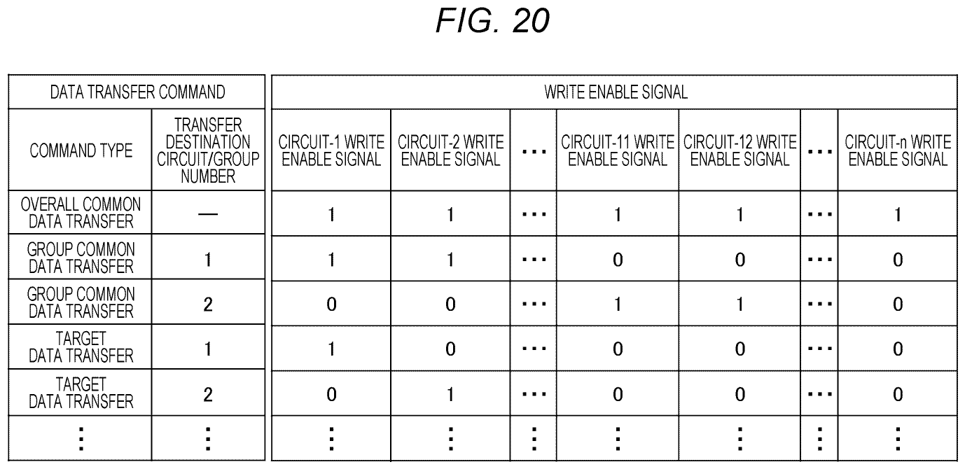

FIG. 20 is a diagram illustrating an example of a configuration of a write enable signal generated by the write signal generation unit according to the second embodiment. Similarly to FIG. 10, FIG. 20 also illustrates the data transfer command input to the write signal generation unit 902. The write signal generation unit 902 receives the command type and transfer destination circuit/group number in the data transfer command as inputs and generates a write enable signal. Similarly to the write enable signal according to the first embodiment illustrated in FIG. 10, the write enable signal includes each 1-bit circuit write enable signal (circuit-1 write enable signal to circuit-n write enable signal) for each of Circuits 1 to n, which are sets of the speed-up circuits 202 and the data write circuits 203.

In a case where the command type indicates the overall common data transfer or target data transfer, the write signal generation unit 902 generates the write enable signal as described in the description with reference to FIG. 10. In a case where the command type indicates the group common data transfer, the write signal generation unit 902 acquires and refers to the configuration information of the group designated by the transfer destination group number from the group management unit 1801, sets all circuit write enable signals for two or more circuits belonging to this group to “1”, and sets all other circuit write enable signals to “0”, thereby generating the write enable signal.

In a case where the group configuration information held by the group management unit 1801 is configured by 1-bit data for each of Circuits 1 to n as illustrated in FIG. 19, the group configuration information has the similar configuration to the write enable signal, so the write signal generation unit 902 can use (output) the configuration information of the group acquired from the group management unit 1801 as it is, as the write enable signal. Further, in a case where the group configuration information held by the group management unit 1801 is configured to designate a range of two or more circuits belonging to each group, that is, to include only data indicating the start point circuit number and the end point circuit number, the write signal generation unit 902 sets all circuit write enable signals for two or more circuits included in the range designated by the start point circuit number and the end point circuit number to “1”, and sets all other circuit write enable signals to “0”, thereby generating the write enable signal.

As described above, according to the information processing device in the second embodiment, by the newly prepared group management command and group management unit, one or a plurality of groups can be freely set for all speed-up circuits provided in the information processing device, and by the group common data transfer command which has been newly prepared in the same manner, the same common data can be transferred by designating the group. As a result, in addition to the effects similar to those of the first embodiment, even in a case where some speed-up circuits corresponding to respective control targets perform arithmetic operation processing by using common information regarding some control targets having the same attributes such as the type and disposition location, it is possible to significantly shorten the data transfer time between the CPU and some speed-up circuits.

Hitherto, although the embodiments of the present invention have been described in detail above, the present invention is not limited to the above-described embodiments, and various design changes can be made without departing from the spirit of the present invention described in the claims. For example, the above embodiments are described in detail in order to explain the present invention in an easy-to-understand manner, and the above embodiments are not necessarily limited to a case including all the described configurations. Further, a part of the configuration in one embodiment can be replaced with the configuration in another embodiment, and the configuration of another embodiment can be added to the configuration of one embodiment. Further, regarding some components in the embodiments, other components can be added, deleted, and replaced.

What is claimed is:

1. An information processing device comprising:
a plurality of speed-up circuits that execute specific arithmetic operation processing;
a CPU that holds a plurality of pieces of transfer data to be transferred to one or a plurality of the speed-up circuits and a plurality of data transfer commands for an instruction to transfer the transfer data to one or a plurality of the speed-up circuits;
a plurality of data write circuits that are provided for the respective speed-up circuits, each of which writes the transfer data to the speed-up circuit;
a write destination determination circuit that outputs a write instruction signal for an instruction to write the transfer data to the speed-up circuit, to one or a plurality of the data write circuits according to the data transfer command output from the CPU; and
a data transfer circuit that transfers the transfer data output from the CPU to each of the data write circuits.

2. The information processing device according to claim 1, wherein
the transfer data includes common data used by all the speed-up circuits for arithmetic operation processing, and
the data transfer command includes a common data transfer command for an instruction to transfer the common data to all the speed-up circuits.

3. The information processing device according to claim 2, wherein the write destination determination circuit outputs a write instruction signal for instructing all the data write circuits to perform writing according to the common data transfer command.

4. The information processing device according to claim 1, wherein
the transfer data includes target data individually used by each of the speed-up circuits for arithmetic operation processing, and
the data transfer command includes a target data transfer command for designating the one speed-up circuit and performing an instruction to transfer the target data.

5. The information processing device according to claim 4, wherein the write destination determination circuit outputs a write instruction signal for instructing only the data write circuit corresponding to the designated speed-up circuit to perform writing according to the target data transfer command.

6. The information processing device according to claim 1, wherein
different circuit numbers are assigned in advance to the respective speed-up circuits, and
in the data transfer command, the speed-up circuit is designated by the circuit number, and an instruction to transfer the transfer data is performed.

7. The information processing device according to claim 1, wherein
the CPU further holds a group management command for designating at least two or more of the speed-up circuits and setting a group, and
the information processing device further comprises:
a group management unit that generates and holds group configuration information including information of the at least two or more speed-up circuits constituting the group and a group number assigned to the group for each group set according to the group management command output from the CPU.

8. The information processing device according to claim 7, wherein
the transfer data includes group common data used for arithmetic operation processing by the at least two or more speed-up circuits constituting the group, and
the data transfer command includes a group common data transfer command for designating the group by the group number and performs an instruction to transfer the group common data.

9. The information processing device according to claim 8, wherein the write destination determination circuit refers to the group configuration information including the designated group number among pieces of the group configuration information held by the group management unit according to the group common data transfer command, and outputs a write instruction signal for instructing, to perform writing, only at least two or more data write circuits corresponding to the at least two or more speed-up circuits constituting the group to which the group number is assigned.

10. An information processing system comprising:
at least
one or a plurality of control targets;
a control apparatus that controls each of the control targets,
wherein the control apparatus includes
the information processing device according to claim 1, and
a communication device that communicates with each of the one or plurality of control targets.

11. An information processing method in an information processing device including a plurality of speed-up circuits that execute specific arithmetic operation processing, a CPU that holds a plurality of commands including a plurality of pieces of transfer data to be transferred to one or a plurality of the speed-up circuits and a data transfer command for an instruction to transfer the transfer data to one or a plurality of the speed-up circuits, and a plurality of data write circuits that are provided for the respective speed-up circuits, each of which writes the transfer data to the speed-up circuit, the information processing method comprising:
simultaneously transferring the transfer data output from the CPU to each of the data write circuits; and
instructing one or a plurality of the data write circuits to write the transfer data to the speed-up circuit according to the data transfer command output from the CPU.

12. The information processing method according to claim 11, wherein
the transfer data includes common data used by all the speed-up circuits for arithmetic operation processing,
the data transfer command includes a common data transfer command for an instruction to transfer the common data to all the speed-up circuits, and
an instruction to perform writing to all the data write circuits is performed according to the common data transfer command.

13. The information processing method according to claim 11, wherein
the transfer data includes target data individually used for arithmetic operation processing by each of the speed-up circuits,
the data transfer command includes a target data transfer command for designating the one speed-up circuit and performing an instruction to transfer the target data, and
only the data write circuit corresponding to the designated speed-up circuit is instructed to perform writing according to the target data transfer command.

14. The information processing method according to claim 11, wherein
the command further includes a group management command for designating at least two or more of the speed-up circuits and setting a group,
the transfer data includes group common data used for arithmetic operation processing by the at least two or more speed-up circuits constituting the group,
the data transfer command includes a group common data transfer command for designating the group and performing an instruction to transfer the group common data,
group configuration information including information of the at least two or more speed-up circuits constituting the group is generated and held for each group set according to the group management command output from the CPU,
the group configuration information of the designated group is referred to among pieces of the group configuration information according to the group common data transfer command, and
only at least two or more of the data write circuits corresponding to the at least two or more speed-up circuits constituting the group are instructed to perform writing.
